(19) United States
(12) Patent Application Publication
(10) Pub. No.: US 2012/0265801 A1
(43) Pub. Date: Oct. 18, 2012

(54) OUT OF ORDER ASSEMBLING OF DATA PACKETS

(75) Inventors: Balendran Mugundan, Redmond, WA (US); Peter Gvozdjak, Sammamish, WA (US); Sapna Jeswani, Seattle, WA (US); Jimmy Yu Wu, Bellevue, WA (US); Raghu Ram, Redmond, WA (US); Chadwin James Mumford, Woodinville, WA (US)

(73) Assignee: Microsoft Corporation, Redmond, WA (US)

(21) Appl. No.: 13/086,269

(22) Filed: Apr. 13, 2011

(51) Int. Cl. G06F 15/16

(52) U.S. Cl. 709/203; 709/201

(57) ABSTRACT

A data transfer is received and processed out of order based on contextual information provided by the sending computer. Individual packets within a data transfer are marked as requiring in order processing while the remaining packets of the data transfer are processed out of order. The packets may be labeled with a sequential identifier to enable the receiving computer to determine the proper ordering of packets that require in order processing.

### CROSS-REFERENCE TO RELATED APPLICATIONS

Not Applicable.

### BACKGROUND

### Background and Relevant Art

Many computing devices contain multiple physical network devices. For example, a computer can contain an Ethernet network interface card, an 802.11 network interface card, and oftentimes other network interface cards. Additionally, each different physical network device may employ different network packet routing systems. For example, when an application desires to communicate data over a network, a connection is established via one of the physical network devices. The data is then transmitted over the network in a format that conforms to the network packet routing system (e.g. TCP/IP) employed by the physical network device used to establish the connection.

The bandwidth of a network connection is generally limited by the maximum data rate at which the physical network device used to create the connection is capable of operating. Most processors are capable of generating or processing data faster than the data can be transferred over a network connection. Thus, the bandwidth of a connection is often a limiting factor in the overall performance of an application. That is, the application would be capable of executing more quickly if it were able to send and receive data more quickly.

### BRIEF SUMMARY

The present invention extends to methods, systems, and computer program products for out of order assembling of data packets. In some embodiments, a first computer establishes a connection with a second computer to receive a data transfer from the second computer. The data transfer is divided into a plurality of packets. The first computer receives two or more packets of the data transfer that each includes a flag indicating that the two or more packets are part of a set of packets that is to be processed in order. In contrast, the first computer receives one or more other packets of the data transfer that each do not include a flag indicating that the one or more other packets do not require in order processing. The first computer processes each packet of the data transfer including processing the one or more other packets as the one or more other packets are received regardless of the order in which the one or more other packets are received, and processing the two or more packets that include the flag in order according to a sequence identifier included in each of the two or more packets. Accordingly, the packets of the data transfer are processed in an order that is different from the order of the packets of the data transfer prior to the packets being sent by the second computer to the first computer.

In other embodiments, a first computer generates data of a data transfer. The first computer divides the data of the data transfer into a plurality of packets. The first computer determines that a first subset of the packets, that does not include all the packets, must be processed in order. The first computer assigns a sequence identifier to each of the packets in the first subset. The first computer also sets a flag in each of the packets of the first subset to indicate that the packets of the first subset must be processed in order. The first computer then sends the packets of the data transfer to the second computer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a computer architecture that facilitates out of order assembly of data packets.

FIG. 2 illustrates a computer architecture in which a first computer transfers result sets to a second computer.

FIG. 3 illustrates an example flowchart of a method for processing packets of a data transfer out of order.

FIG. 4 illustrates an example flowchart of a method for marking packets of a data transfer to enable a receiving computer to process some of the packets of the data transfer out of order.

FIG. 5 illustrates a network architecture in which a first computer marks packets of a data transfer to enable out of order processing by a second computer.

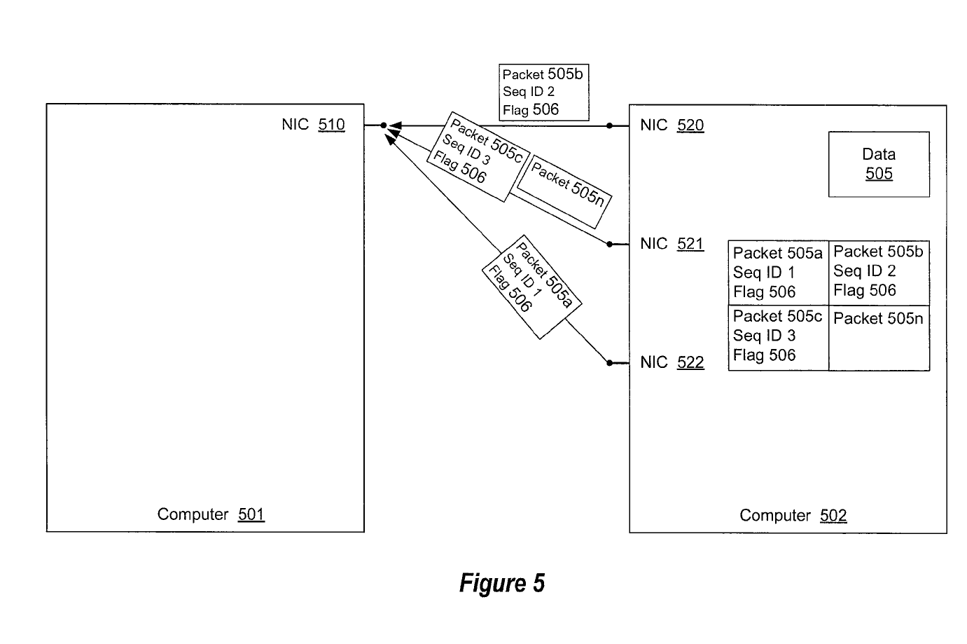

### DETAILED DESCRIPTION

The present invention extends to methods, systems, and computer program products for out of order assembling of data packets. In some embodiments, a first computer establishes a connection with a second computer to receive a data transfer from the second computer. The data transfer is divided into a plurality of packets. The first computer receives two or more packets of the data transfer that each includes a flag indicating that the two or more packets are part of a set of packets that is to be processed in order. In contrast, the first computer receives one or more other packets of the data transfer that each do not include a flag indicating that the one or more other packets do not require in order processing. The first computer processes each packet of the data transfer including processing the one or more other packets as the one or more other packets are received regardless of the order in which the one or more other packets are received, and processing the two or more packets that include the flag in order according to a sequence identifier included in each of the two or more packets. Accordingly, the packets of the data transfer are processed in an order that is different from the order of the packets of the data transfer prior to the packets being sent by the second computer to the first computer.

In other embodiments, a first computer generates data of a data transfer. The first computer divides the data of the data transfer into a plurality of packets. The first computer determines that a first subset of the packets, that does not include all the packets, must be processed in order. The first computer assigns a sequence identifier to each of the packets in the first subset. The first computer also sets a flag in each of the packets of the first subset to indicate that the packets of the first subset must be processed in order. The first computer then sends the packets of the data transfer to the second computer.

Data transfers that are divided into multiple packets that are separately transmitted over a network are processed out of order. The packets may be processed in the order received. In addition, at least some of the packets can be marked as requiring in order processing to indicate to the receiving computer that the marked packets must be processed in a proper order as indicated by sequence identifiers included with the packets.

Out of order processing may be used over a single network connection or in conjunction with logical connections. A logical connection includes one or more physical network connections that may be concurrently or consecutively established. Whether concurrently or consecutively established, multiple physical network connections may be established using the same or different physical network devices. A logical connection functions to abstract the underlying physical connection from the connection at the application level. Thus, a switch from one physical network connection to another is transparent to the application.

An example logical connection includes two or more physical connections between a client computer and a database server when the client computer submits a database request to the database server. The client computer contains multiple physical network devices that are each individually capable of establishing a physical network connection to send and/or receive data. The database server responds to the client's database request by creating a response (e.g. rows of data from the database) that is divided into packets. These packets are sent to the client. Different packets of the response are sent to different physical network devices of the client. Thus, the single response is divided and sent over multiple physical network connections of the logical connection. Although the above example describes a logical connection between a client and a server, the present invention extends to logical connections between any two computers connected in any network topology such as client/server and peer-to-peer topologies.

For example, a computer having both an Ethernet network interface card (NIC) and an 802.11 NIC can expose different IP addresses for each NIC. Rather than send the response to a single IP address associated with a single NIC, embodiments of the invention would send packets of the response to each of the NICs. In this manner, the data is transmitted to the computer more quickly because the bandwidth provided by the network connections of each NIC is used to receive the data. Two or more physical network devices of the same type (e.g. two Ethernet NICs) could also be used to establish the logical connection. The invention is not limited to any particular network packet routing protocol. Any network packet routing protocol can be used for any of the individual network connections. Further, different physical network connections within the same logical connection can use different network packet routing protocols.

Multiple physical network devices in a logical connection can be used to send data to a computer. For example, a database server can employ a logical connection to send a response to a client. The logical connection can employ multiple physical network devices to send the data. For example, packets of the response could be divided and sent over different NICs on the database server.

Thus, multiple physical network devices can be used on both ends of a logical connection. In such an embodiment, the sending and the receiving computers both employ multiple physical network devices. For example, the database server could send the response to multiple physical network devices of the client using multiple of its own physical network devices.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed by a general purpose or special purpose computer.

A “network” is defined as one or more data links that enable the transport of electronic data between computers and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer RAM and/or to less volatile computer storage media (devices) at a computer. Thus, it should be understood that computer storage media (devices) can be included in computer components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computers, which are linked (either by hardwired data links, wireless data links, or by a combination of hardwired and wireless data links) through a network, both perform tasks. In a distributed system environment, program modules may be located in both local and remote memory storage devices.

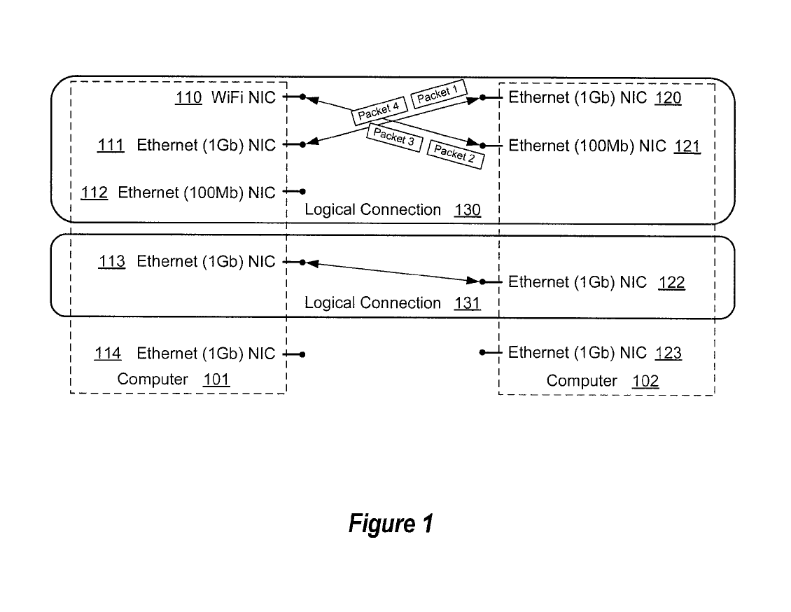

FIG. 1 illustrates an example of two computers between which two logical connections have been established. Computer 101 contains five physical network devices: a WiFi NIC 110, 1 Gb Ethernet NIC 111, 100 Mb Ethernet NIC 112, 1 Gb Ethernet NIC 113, and 1 Gb Ethernet NIC 114. Computer 102 contains four physical network devices: 1 Gb Ethernet NIC 120, 100 Mb Ethernet NIC 121, 1 Gb Ethernet NIC 122, and 1 Gb Ethernet NIC 123.

Two logical connections are illustrated between computer 101 and computer 102. Logical connection 130 includes computer 101's WiFi 110, 1 Gb Ethernet 111, and 100 Mb Ethernet 112 NICs, and computer 102's 1 GB Ethernet 120 and 100 Mb Ethernet 121 NICs. The data transfer being transmitted includes four packets. Packets 1 and 4 are transmitted from 1 Gb Ethernet NIC 111 to 1 Gb Ethernet NIC 120, whereas packets 2 and 3 are transmitted from WiFi NIC 110 to 100 Mb Ethernet NIC 121. Although 100 Mb Ethernet NIC 112 is part of logical connection 130, 100 Mb Ethernet NIC 112 is not being used to transmit packets of the data transfer.

Logical connection 131 includes 1 Gb NIC 113 and 1 Gb NIC 122. Accordingly, embodiments include computers and/or applications that utilize two logical connections concurrently. For example, the same application could use both logical connection 130 and logical connection 131 to transfer data. In one embodiment, a database client concurrently uses two logical connections for two separate queries to the same database server.

Embodiments of the invention include adding a physical network device to or removing a physical network device from a logical connection. A physical network device can be added or removed at any time before, during, or after a data transfer. For example, logical connection 131 can be modified to include 1 Gb Ethernet NIC 114 at any time to increase network throughput available to an application executing on computer 101. 1 Gb Ethernet NIC 114 can be added to logical connection 131 based on data and/or network characteristics. For example, 1 Gb Ethernet NIC 114 can be added prior to commencing the transmission of a large data transfer in response to a determination by computer 101 that more network bandwidth would be desirable. Alternatively, 1 Gb Ethernet NIC 114 can be added during the transmission of the large data transfer upon determining that the data transfer would benefit from additional bandwidth. In such embodiments, a first computer may initially have a single physical network connection to a second computer, but may add another physical network connection to create a logical connection between the first and second computers.

On the other hand, a physical network device can be removed from a logical connection at any time. For example, it may be determined that a particular logical connection is consuming too much of the bandwidth capability of computer 101. In response, one or more physical network devices are removed from the logical connection. For example, if during transmission of a data transfer, it is determined that logical connection 130 is consuming too much bandwidth, 1 Gb Ethernet NIC 111 can be removed from logical connection 130. Whether a physical network device is added to or removed from a logical connection, the data to be transmitted or being transmitted over the logical connection is unaffected (i.e. the data will still be transmitted successfully over the physical network devices that remain part of the logical connection without having to restart the transmission).

Although FIG. 1 illustrates that logical connection 130 involves multiple physical network devices on both computer 101 and computer 102, a logical connection according to the invention may be established between multiple physical network devices on one side of the logical connection and a single physical network device on the other. For example, 100 Mb Ethernet NIC 121 could be removed from logical connection 130. In this scenario, all packets of the data transfer being sent by computer 102 to computer 101 over logical connection 130 would be sent via 1 Gb Ethernet NIC 120 to any of computer 101's three NICs included in logical connection 130. Similarly, all packets of the data transfer sent by computer 101 to computer 102 over logical connection 130 would be divided among computer 101's three NICs that are included in logical connection 130 and sent to computer 102's 1 Gb Ethernet NIC 120.

Data may be divided among the different physical network devices of a logical connection based on functionality. For example, a particular physical network device of a logical connection may be reserved for sending and/or receiving control information while the remaining physical network devices of the logical connection are used for data transfers. Any other usage restrictions may also be employed within a logical connection.

Data may also be divided among physical network devices of a logical connection based on other factors such as load balancing, link speed, etc. For example, if a logical connection consists of a 100 Mb Ethernet connection and a 54 Mb 802.11g connection, the sender may choose to send two data packets through the 100 Mb Ethernet connection per each data packet sent through the 54 Mb 802.11g connection.

Which physical network devices are used in a logical connection, how data packets are divided among the physical network devices, when physical network devices are added or removed from a logical connection, and the like can be user configurable options. For example, an application on computer 101 desiring to use a logical connection to communicate with computer 102 may be pre-configured to use a host file that defines the set of network addresses (i.e. the addresses of the physical network devices) of computer 102. These addresses could also be obtained by querying the DNS for the entire list of network addresses for computer 102. However, the manner in which the network addresses of a particular computer are obtained are not essential to the invention.

A packet as referred to above differs from a packet of a network routing protocol such as an IP packet. Packet is used to denote that the data transfer can be divided into multiple packets. For example, if the data transfer is the result of a database query—such as multiple rows of data, the packets may comprise the individual rows of data. In this sense, a packet would contain a row. However, the same packet at the lower levels of the protocol stack, such as the TCP and IP layers, would likely be further divided into multiple TCP or IP packets. In other words, a single row (or packet) may be divided into multiple IP packets. A packet is not limited to a database row. In some embodiments, a row is divided among two or more packets, such as in the case where a row is too large to fit in a single packet.

A data transfer (e.g. database query result) can be divided into multiple packets so that the packets can be divided among a plurality of physical network devices to be concurrently transmitted over multiple different network connections to the same computer. For example, multiple physical network connections can be used to send a database query result (e.g. between one 1 Gb Ethernet NIC on the database server and 10 100 Mb Ethernet NICs on the client). Accordingly, query results can be received more quickly.

Thus, a single data transfer can be divided and sent over multiple physical network devices. For example, when a database query returns five rows of data, all five rows can be sent over a logical connection. The rows can be allocated to physical network devices based on any number of different approaches. For example, a first and fourth packet containing the first and fourth rows respectively can be sent over a first physical network device, a second and fifth packet containing the second and fifth rows respectively can be sent over a second physical network device, and a third packet containing the third row can be sent over a third physical network device. This is an example of a round robin approach to dividing the packets over the physical network devices of a logical connection. Other schemes for dividing the packets could also be used. Although rows of a database result are used in the above examples, the invention extends to the transfer of any data over a logical connection.

In the above example, each individual physical network device can communicate its allocated packets according to the device's packet routing protocol (which may be different from the packet routing protocol used by another device in the logical connection). For example, if a first physical network device is an Ethernet NIC that employs standard TCP/IP, the first and fifth packets can be subdivided into TCP and IP packets and transmitted over the network connection to the client computer. Likewise, if the second physical network device is a 3G/4G NIC that employs UDP, the second and fourth packets can be subdivided into UDP packets and transmitted over the network connection to the client computer.

When a logical connection is used to transfer data, the order in which the packets of the data transfer are received may not match the original order of the packets (i.e. the order of the data transfer before being transmitted), or the order in which the packets of the data transfer were sent. Referring back to the same example, the third packet may be received over the third network connection prior to the first, second, fourth, and fifth packets being received over the first and second network connections. In implementations where order is not relevant, the packets can be processed on the receiving computer in whatever order they are received. On the other hand, in situations where the order of the packets is relevant, embodiments of the invention employ a sequencing scheme to identify the order of the packets to enable the client computer to reconstruct the data transfer in the proper order.

The sequencing scheme provides a unique identifier to each packet that must be processed in order to identify the sequential order of the packets. By reading the identifiers, the receiving computer is able to determine which packet is the next sequential packet in the data transfer. In embodiments where the next packet is not received over the same physical network device as the previous packet in the sequence, the receiving computer may read from each of the other physical network devices in the logical connection to locate the next packet in the sequence. Thus, although send and receive ordering of packets may differ, the packets can still be processed in order. For example, the sequencing scheme can ensure that the packets are processed and supplied to a requesting application in the proper sequential order.

This sequencing scheme can also apply to subsets of the data transfer to indicate that partial ordering of the data transfer is required. In other words, only some of the packets in the data transfer may require in order processing. In such embodiments, the packets that do not require in order processing may be processed whenever they are received. In some embodiments, only the packets that require in order processing are assigned a sequence identifier. These packets can also be assigned a flag to indicate to the receiving computer which packets require in order processing.

Further, in embodiments where a data transfer includes multiple sets that each require in order processing of the packets within each set, a different flag can be assigned to the packets of each set to indicate to which set the packets belong. For example, a first set of packets in the data transfer may be assigned a first flag, while a second set of packets in the data transfer may be assigned a second flag. In such embodiments, the sequence identifiers assigned to each set may also be independent. In other words, each set may be assigned sequence identifiers starting with the same number to indicate which packet in each set is the first packet of the set (e.g. the first packet in each set is assigned the number 1 as the sequence identifier).

Partial ordering may be appropriate when an item of the data transfer does not fit within the defined size of the packets. For example, if a data transfer is a batched database query being sent from a client to a database server, one item of the batch may be too large to fit within a packet. In this scenario, the item can be split between two or more packets which must be processed in order. At the same time, the remaining items of the batch may all fit within a single packet and may be processed in whatever order they are received. Another example is when a row of a database query result is too large to fit inside a single packet. In these embodiments, the row is split between two or more packets which will require in order processing at the receiving computer. It is to be understood that processing in order does not necessarily mean processing one packet before another, but could include processing two packets that require ordering at the same time.

Although the above description refers to the ordering of packets as they are sent, it is to be understood that embodiments of the invention do not require that the packets be physically sent in the proper order. Send order should be understood as the proper ordering of the packets based on how the data was divided into packets. Once divided, the packets could be physically sent over multiple physical network devices from the sending computer in various orders. Thus, an appropriate sequence can be construed as the sequence of the data prior to the data being divided into packets and sent over a logical connection.

An example of a data transfer that could be ordered is the result of the query select col1, col2, col3 from table1 order by col1. Another example is select y . . . sort by . . . . The responses to these queries can be passed to the requesting application in the proper order. To achieve this ordering, the described sequencing scheme could be used to identify the proper sequence of the packets that contain the results of each query.

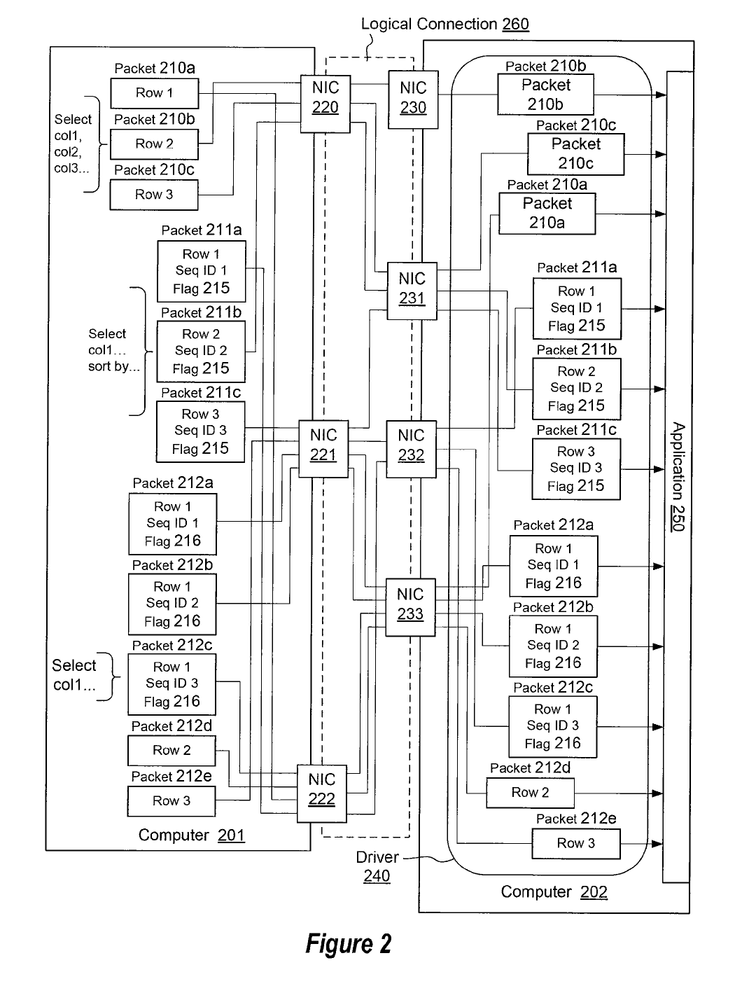

FIG. 2 illustrates an example of a computer 201 and a computer 202 between which a logical connection has been established for sending results of database queries to computer 202. Although this figure illustrates a logical connection being used to send the results, embodiments of the invention may be applied when a logical connection is not used. For example, the invention may be used to process packets of a result out of order when a single physical connection is used to transmit all packets of the result.

FIG. 2 illustrates how the result sets of three different queries are processed. Result set 210, of the query select a, b, c . . . , is not dependent on order. Accordingly, FIG. 2 shows that the individual packets 210a-210c of result set 210, which contain rows 1-3 respectively, are processed (at computer 202) in the order they are received by computer 202 with packet 210a, which contains row 1, being processed after packet 210b, which contains row 2, and packet 210c, which contains row 3.

In contrast, result set 211, of the query select y . . . sort by . . . , is dependent on order. FIG. 2 therefore shows that the packets 211a-211c of result set 211 are processed in order. To enable processing of the packets of result set 211 in order, each of the packets 211a-211c, which contain rows 1-3 respectively, is assigned a sequence identifier and given a flag 215 which is used by driver 240 to reconstruct the packets so that they are passed to the application 250 in the proper order.

Finally, result set 212, of the query select z . . . , is partially dependent on order because row 1 is split between three packets (packets 212a-212c). Accordingly, packets 212a-212c are each assigned a sequence identifier and given a flag 216. The remaining packets of result set 212 (packets 212d and 212e) each include an entire row. Therefore, packets 212d and 212e are not assigned a sequence identifier or a flag thus indicating to driver 240 that these packets can be processed in whatever order they are received.

Although FIG. 2 shows that packets 212d and 212e do not include a sequence identifier, in some embodiments, every packet in a result set can be given a sequence identifier. In such embodiments, the flag is used to identify which packets require in order processing. For example, driver 240 can determine that packets 212d and 212e do not require in order processing because they do not contain flag 216 or another similar flag.

FIG. 2 also provides an example of how a logical connection may function. As shown, the individual packets of each result set can be routed over different NICs within the logical connection 260 between computer 201 and computer 202. For example, packets 211a-211c of result set 211 are shown as each being sent over a different NIC (222, 220, and 221 respectively) of computer 201. FIG. 2 also illustrates that the same NIC on computer 201 is not required to send packets to the same NIC of computer 202. For example, NIC 220 is shown as sending packets to both NIC 230 and NIC 231 of computer 202. However, it is possible to configure the system such that a particular NIC on computer 201 always sends packets to the same NIC on computer 202, and vice versa.

FIG. 2 is an example of a many-to-many logical connection. However, a one-to-many logical connection can also be used. A one-to-many logical connection would exist if computer 202 had only a single NIC to which all packets of the result sets where sent.

One embodiment in which out of order processing may be particularly beneficial is when the receiving computer includes multiple processors for processing the received packets. The packets can be split among the multiple processors for processing without the overhead of ensuring that they are processed in order.

In some embodiments, a connection ID may be used to identify which physical connections are included in a logical connection. For example, each network connection established by a physical network device included in a logical connection can be assigned the same connection ID.

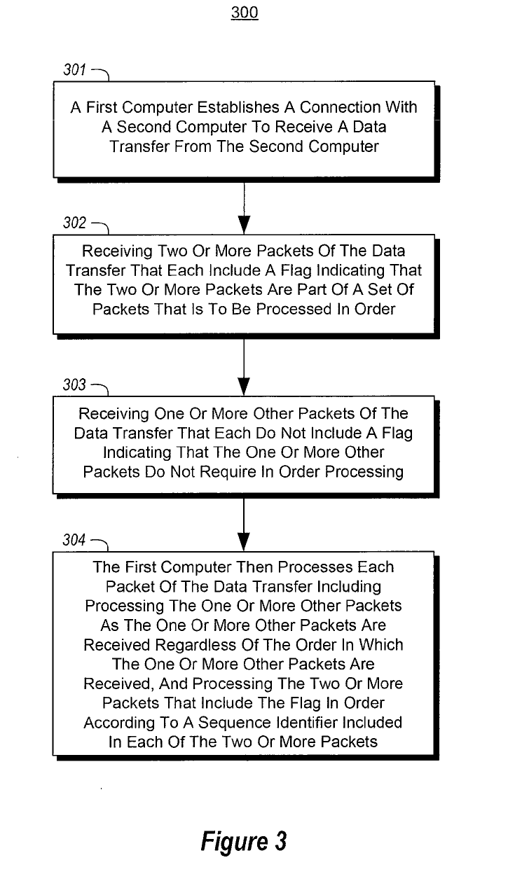

FIG. 3 provides a flowchart of a method 300 for processing packets of a data transfer out of order. The steps of method 300 will be described with reference to FIG. 2. A first computer establishes a connection with a second computer to receive a data transfer from the second computer (act 301). For example, computer 202 establishes a connection with server 201. The data transfer is divided into a plurality of packets. For example, the data transfer may comprise result set 212. The data transfer may comprise a database query or the results of a database query.

The first computer receives two or more packets of the data transfer that each include a flag indicating that the two or more packets are part of a set of packets that is to be processed in order (act 302). For example, computer 202 may determine that portions 212a-212c each include flag 216.

The first computer receives one or more other packets of the data transfer that each do not include a flag indicating that the one or more other packets do not require in order processing (act 303). For example, computer 202 can determine that packet 212d and 212e do not include a flag and can therefore be processed out of order. The first computer processes each packet of the data transfer including processing the one or more other packets as the one or more other packets are received regardless of the order in which the one or more other packets are received, and processing the two or more packets that include the flag in order according to a sequence identifier included in each of the two or more packets, (act 304). For example, computer 202 can process packets 212a-212c in the order defined by the sequence identifiers included in each packet even if packets 212a-212c are received in a different order, whereas packets 212d and 212e can be processed whenever they are received. The packets are processed in an order that is different from the order of the packets of the data transfer prior to the packets being sent by the second computer to the first computer.

The method 300 may also include processing the received packets on the first computer with multiple processors of the first computer. In such embodiments, processing packets in order may comprise processing the packets simultaneously.

In some embodiments, a packet may comprise a query such as when the data transfer is a batch of database queries, or a packet may comprise a row of data such as when the data transfer is a result of executing one or more database queries. In such embodiments, ordering of packets may not be important except for in instances where a query or a row of data will not fit within the size allotted to a single packet. In these instances, a query or a row may be contained in two or more packets which are required to be processed in order. These packets which contain only part of a row or a query may include a set flag to indicate that they must be processed in order while all other packets of the data transfer may be processed out of order. For example, packets 212a-212c each contain a portion of row 1 while packet 212d contains the entire row 2 and packet 212e contains the entire row 3.

In some embodiments, only the packets that require in order processing contain a sequence identifier such as packets 212a-212c. However, in other embodiments, all packets of a data transfer, even those that may be processed in any order such as packets 212d and 212e, may be given a sequence identifier.

In some embodiments of method 300, the packets of the data transfer may be received over multiple physical network devices of a logical connection such as logical connection 260. In such embodiments, the first computer may contain multiple physical network devices that each receives a subset of the packets of the data transfer. Each packet may be processed as it is received at one of the physical network devices regardless of the order in which the packets are received at the first computer. Such embodiments may also include reading from each physical network device to locate the next sequential packet of the data transfer when the data transfer includes packets that must be processed in order. For example, if the data transfer includes first, second, and third packets that must be processed in order, and the first and third packets are received on a first physical network device of the logical connection, the first computer may read the first packet, and then read from each other physical network device to locate the second packet prior to returning to read the third packet from the first physical network device.

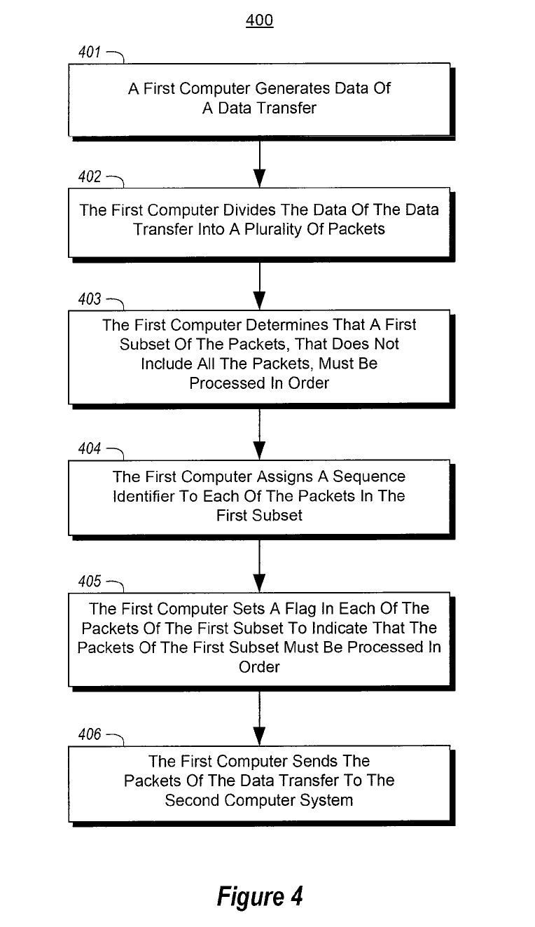

FIG. 4 provides a flowchart of a method 400 for a first computer marking packets of a data transfer to be sent to a second computer to enable the second computer to process some of the packets of the data transfer out of order. The first computer generates data of a data transfer (act 401). For example, computer 502 may generate data 505. The data may comprise a batch of queries to be sent to a database server, or may include the results of the execution of one or more database queries to be sent to a client. The first computer divides the data of the data transfer into a plurality of packets (act 402). For example, computer 502 may divide data 505 into packets 505a-505n.

The first computer determines that a first subset of the packets, that does not include all the packets, must be processed in order (act 403). For example, computer 502 may determine that packets 505a-505c must be processed in order. The first computer assigns a sequence identifier to each of the packets in the first subset (act 404). For example, computer 502 may assign sequence identifiers 1-3 to packets 505a-505c respectively. The first computer also sets a flag in each of the packets of the first subset to indicate that the packets of the first subset must be processed in order (act 405). For example, flag 506 may be set in packets 505a-505c. The first computer then sends the packets of the data transfer to the second computer (406). For example, computer 502 sends packets 505a-505n to server 501.

Other embodiments include setting a flag in every packet of the data transfer to indicate that the entire data transfer requires in order processing.

In some embodiments of method 400, the packets of the data transfer may be sent over multiple physical network devices of a logical connection. In such embodiments, the first computer may contain multiple physical network devices, two or more of which are grouped into a logical connection for sending the packets of the data transfer. The first computer may divide the packets between the two or more physical network devices to be sent to the second computer. For example, computer 502 includes NICs 520-522, each of which sends at least one of the packets 505a-505n to server 501.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a first computer that includes one or more processes and system memory, a method for processing packets of a data transfer out of order, comprising:
establishing a connection with a second computer to receive a data transfer from the second computer, the data transfer being divided into a plurality of packets;
receiving two or more packets of the data transfer, each of the two or more packets including a flag indicating that the two or more packets are part of a set of packets that is to be processed in order;
receiving one or more other packets of the data transfer, each of the one or more other packets not including a flag indicating that the one or more other packets do not require in order processing; and
processing each packet of the data transfer including processing the one or more other packets as the one or more other packets are received regardless of the order in which the one or more other packets are received, and processing the two or more packets that include the flag in order according to a sequence identifier included in each of the two or more packets, wherein the packets of the data transfer are processed in an order that is different from the order of the packets of the data transfer prior to the packets being sent by the second computer to the first computer.

2. The method of claim 1, wherein the first computer is a database server, and the data transfer comprises one or more database queries.

3. The method of claim 2, wherein each packet of the data transfer comprises a query of a batch of queries.

4. The method of claim 1, wherein the data transfer is a batch of database queries, and wherein receiving the two or more packets comprises receiving one of the queries in the batch of database queries that is split between the two or more packets.

5. The method of claim 1, wherein the first computer is a client and the second computer is a database server, and the data transfer comprises results of the execution of one or more database queries.

6. The method of claim 5, wherein each packet comprises a row of data from the results of the execution of the one or more database queries.

7. The method of claim 5, wherein receiving the two or more packets comprises receiving one of the rows that is split between the two or more packets of the data transfer.

8. The method of claim 1, wherein the connection comprises a logical connection that includes two or more physical network devices on the first computer, and wherein different packets of the data transfer are received over different physical network devices of the logical connection.

9. The method of claim 1, wherein the first computer includes multiple processors that process different packets of the data transfer as the packets are received.

10. In a first computer that includes one or more processors and system memory, a method of marking packets of a data transfer to be sent to a second computer to enable the second computer to process some of the packets of the data transfer out of order, comprising:
generating data of a data transfer;
dividing the data of the data transfer into a plurality of packets;
determining that a first subset of the packets, that does not include all the packets of the data transfer, must be processed in order;
assigning a sequence identifier to each of the packets in the first subset;
setting a flag in each of the packets of the first subset to indicate that the packets of the first subset must be processed in order; and
sending the packets of the data transfer to the second computer.

11. The method of claim 10, wherein the data transfer comprises a batch of queries to be sent to the second computer.

12. The method of claim 11, wherein the batch of queries includes a first query that is divided among the packets of the first subset.

13. The method of claim 10, wherein the data transfer comprises results of the execution of one or more database queries to be sent to the second computer.

14. The method of claim 13, wherein the results of the execution include a plurality of rows, and wherein the packets of the first subset each include part of a row that is divided among the packets of the first subset.

15. The method of claim 10, further comprising:
assigning a sequence identifier to each of the remaining packets in the data transfer such that every packet in the data transfer is assigned a sequence identifier.

16. The method of claim 10, wherein the packets of the data transfer are sent over a logical connection established between the first and second computers, the logical connection including two or more physical network devices on the first computer over which different packets of the data transfer are sent.

17. One or more computer storage media storing computer executable instructions which when executed by one or more processors of a first computer perform a method of processing packets of a data transfer out of order, comprising:
establishing a logical connection with a second computer to receive results of one or more database queries executed by the second computer, wherein the results include a plurality of rows of data from one or more databases, the results being divided into a plurality of packets, wherein at least some packets include only a part, but not all of a row of the results, while the remaining packets each include an entire row of the results, wherein the logical connection includes a plurality of physical network devices that each receive different packets of the data transfer;
receiving a first packet, at any of the plurality of physical network devices in the logical connection, that includes an entire row of the results;
processing the first packet regardless of the order in which the packet is received;
receiving a second packet, at a first physical network device in the logical connection, that includes only a part of a row;
accessing a sequence identifier assigned to the second packet to determine if the packet is being processed in the proper order as identified by the sequence identifier; and
upon determining that the second packet is not the next sequential packet as defined by the sequence identifier, accessing one or more other physical network devices in the logical connection until the next sequential packet of the data transfer is located and processed.

18. The one or more computer storage media of claim 17, detecting that a second packet includes only part of a row by reading a flag in the packet.

19. The one or more computer storage media of claim 17, wherein the second computer is a database server.

20. The one or more computer storage media of claim 17, wherein the physical network devices are network interface cards.
